(19) United States
(12) Patent Application Publication
(10) Pub. No.: US 2013/0158809 A1
(43) Pub. Date: Jun. 20, 2013

(54) METHOD AND SYSTEM FOR ESTIMATING REAL-TIME VEHICLE CRASH PARAMETERS

(71) Applicants: Wilford Trent Yopp, Canton, MI (US); Brian Robert Spahn, Plymouth, MI (US)

(72) Inventors: Wilford Trent Yopp, Canton, MI (US); Brian Robert Spahn, Plymouth, MI (US)

(73) Assignee: FORD GLOBAL TECHNOLOGIES, LLC, DEARBORN, MI (US)

(21) Appl. No.: 13/326,351

(22) Filed: Dec. 15, 2011

(51) Int. Cl. G06F 7/00; B60R 21/0134

(52) U.S. Cl. 701/45; 701/1

(57) ABSTRACT

The disclosure relates to vehicle safety systems, more particularly relates to method to determined real-time crash parameters of the vehicle. A method of estimating real-time vehicle crash parameters, the method determining internal vehicle crash parameters, including determining vehicle-related inputs related to crash parameters; calculating real-time vehicle-related crash parameters by comparing the vehicle-related inputs to predetermined crash parameters; and determining occupant-related crash parameters; determining external crash parameters, including obtaining information related to nearby vehicles; obtaining information related to nearby infrastructure; and calculating likelihood of collision with the nearby vehicles or the infrastructure; and identifying appropriate measures for mitigating occupant injury and vehicle damage, based on feasibility of crash countermeasures application.

### TECHNICAL FIELD

This disclosure relates generally to vehicle safety systems, and more particularly to methods for enhancing the crash survivability of the vehicle and its occupants.

### BACKGROUND

Vehicle safety systems are becoming more complex in order to tailor the system response to different occupants and crash modes. For example, airbag venting and inflation are controlled at various levels and adjusted in harmony with other restraint countermeasures such as seat belt pre-tensioning, load limiting, seats, steering column, etc., to fine-tune system responses for known crash conditions. Such conditions include occupant mass, seatbelt usage, occupant position, and the like. That information is best utilized when identified before the crash, when restraint system variables can be adjusted specifically for expected crash conditions.

Typical sensors detect both internal and external crash-related factors. Regarding the vehicle itself, manufacturers routinely determine vehicle information, such as weight, wheelbase, width, body style and the like, and such information is typically available to an on-board processor. Additionally, vehicles having such safety systems can determine occupant characteristics such as seat belt usage, position, weight, and so on. Additionally, known pre-crash sensors and associated processors can estimate factors related to an anticipated crash, such as time to impact, type of crash (full frontal or partial), and classification of external objects such as person, small car, truck, etc. For optimum protection however, a vehicle safety system should provide additional information about the characteristics of the crash object. To a pre-crash sensor, the back of an empty panel truck and fully loaded panel truck appear to be similar objects, but one can intuitively understand that they have very different crash characteristics. Additional information is therefore needed, where Vehicle-to-Vehicle and Vehicle-to-Infrastructure messages could provide the basic crash characteristics of a vehicle or infrastructure object. Even according to additional external information, however, no information would be available to indicate how the real-time vehicle parameters have varied from as-manufactured values.

Thus, a need remains for a system that can identify and act upon real-time vehicle information to enhance crash survivability.

### SUMMARY

The shortcomings of the prior art are overcome and additional advantages are provided through the provision of a method and a system as described in the following description.

In one non-limiting exemplary aspect, a method of estimating real-time vehicle crash parameters is provided. The method of estimating real-time vehicle crash parameters, the method comprising determining internal vehicle crash parameters, including determining vehicle-related inputs related to crash parameters; calculating real-time vehicle-related crash parameters by comparing the vehicle-related inputs to predetermined crash parameters; and determining occupant-related crash parameters. The method further comprises determining external crash parameters, including obtaining information related to nearby vehicles; obtaining information related to nearby infrastructure; and calculating likelihood of collision with the nearby vehicles or the infrastructure.

In one embodiment, the method further comprises identifying appropriate measures for mitigating occupant injury and vehicle damage, based on feasibility of crash countermeasures application.

In one embodiment, the vehicle-related inputs are vehicle load condition and rolling radius.

In one embodiment, the vehicle load condition is determined using at least one of information about pressure on each tire and average tire pressure measured by tire pressure monitoring system of the vehicle.

In one embodiment, the rolling radius is determined using the vehicle load condition measured by an Anti-lock Braking System of the vehicle.

In one embodiment, the estimated crash parameters are broadcasted to a central server.

In one embodiment, the vehicle is selected from a group comprising moving vehicle, non-moving vehicle, countermeasure vehicle, non-countermeasure vehicle and combinations thereof.

In one embodiment, a system for estimating real-time vehicle crash parameters, the system comprising apparatus for determining internal vehicle crash parameters, including a tire pressure monitoring system adopted to determine vehicle load condition using vehicle-related inputs; an anti-lock brake system configured to calculate vehicle rolling radius based on the determined vehicle load condition. The system further comprise, electronic control unit for calculating real-time vehicle-related crash parameters by comparing the vehicle-related inputs to predetermined crash parameters; occupant identifier to determine occupant-related crash parameters; apparatus for determining external crash parameters, including at least one of GPS sensor and a pre-crash sensing means to obtain information related to nearby vehicles and nearby infrastructure, wherein the pre-crash sensing means calculates likelihood of collision with at least one of the nearby vehicles and infrastructure; a computing unit connectable to the tire pressure monitoring system, the anti-lock brake system, the occupant identifier, GPS sensor, and the pre-crash sensing means to receive corresponding information and to process the received information to estimate the vehicle crash parameters.

In one embodiment, the system further comprise a restraint device connectable to the computing device for receiving the estimated crash parameters to identify appropriate measure for mitigating occupant injury and vehicle damage based on feasibility of crash countermeasures application.

In one embodiment, a vehicle comprising the system for estimating real-time vehicle crash parameters, the system comprising apparatus for determining internal vehicle crash parameters, including a tire pressure monitoring system adopted to determine vehicle load condition using vehicle-related inputs; an anti-lock brake system configured to calculate vehicle rolling radius based on the determined vehicle load condition. The system further comprise, electronic control unit for calculating real-time vehicle-related crash parameters by comparing the vehicle-related inputs to predetermined crash parameters; occupant identifier to determine occupant-related crash parameters; apparatus for determining external crash parameters, including at least one of GPS sensor and a pre-crash sensing means to obtain information related to nearby vehicles and nearby infrastructure, wherein the pre-crash sensing means calculates likelihood of collision with at least one of the nearby vehicles and infrastructure; a computing unit connectable to the tire pressure monitoring system, the anti-lock brake system, the occupant identifier, GPS sensor, and the pre-crash sensing means to receive corresponding information and to process the received information to estimate the vehicle crash parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1A is a flow chart illustrating a method for determining average tire pressure used to calculate vehicle load condition, in accordance with an embodiment of the present disclosure.

FIG. 1B is a flow chart illustrating a method used to estimate real-time vehicle crash parameters, in accordance with an embodiment of the present disclosure.

FIG. 1C is a flow chart illustrating a process for determining the likelihood of collision with nearby vehicles or infrastructure, in accordance with an embodiment of the present disclosure.

FIG. 1D is a flow chart illustrating a method used for estimating occupant injury and vehicle damage mitigation, in accordance with an embodiment of the present disclosure.

FIG. 1E is a flow chart illustrating a method used for determining occupant injury information, based on the feasibility of crash countermeasures application, in accordance with an alternative embodiment of the present disclosure.

FIG. 1F is a flow chart illustrating a further method used for determining occupant injury information in accordance with an alternative embodiment of the present disclosure.

FIG. 1G is a flow chart illustrating a method used for determining occupant injury information, in accordance with an embodiment of the present disclosure.

FIG. 2 shows an exemplary block diagram of a system used for estimating crash parameters of a vehicle according to the disclosure.

FIG. 3 shows an exemplary graph of crash severity vs. type of objects.

### DETAILED DESCRIPTION

### Embodiments

Although the various embodiments of the present disclosure are mainly described in terms of passenger vehicles, the disclosed method would be equally applicable to a broad array of control problems. Generally, the present disclosure can be adapted for control problems where the range of possible physical systems (e.g., vehicle, occupant, and posture) is reasonably narrow; the range of possible events requiring special response (collision scenarios) is also reasonably narrow and of a short transient character; and the complexity of the physical system is high enough to make deterministic state estimation impractical. The term “reasonably narrow” simply meaning it could be expressed in a probability density function.

An example of such a problem is a fault event controller for industrial machinery. Generally, for example, it may be directed to machine fault detection and selection of “best” palliative action. Thus, it should be appreciated that the various embodiments are applicable to fields other than occupant restraint.

It should also be appreciated that the various embodiments are applicable to more than just “frontal vehicle crashes”. Rather the present disclosure is applicable to any general “vehicle crashes” such as applying the algorithms, methods and systems at different crash scenarios, such as side impacts, rear impacts, rollovers, and the like.).

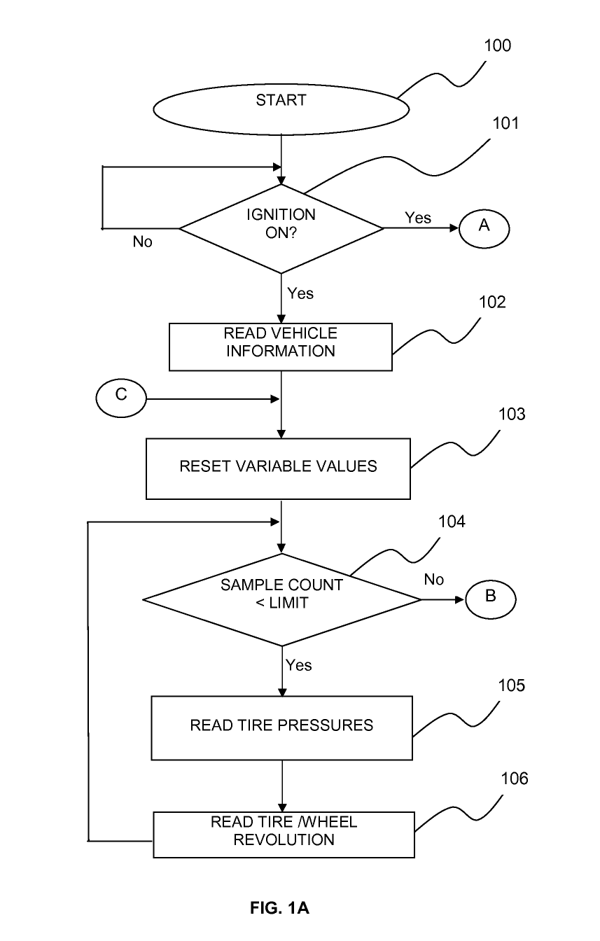

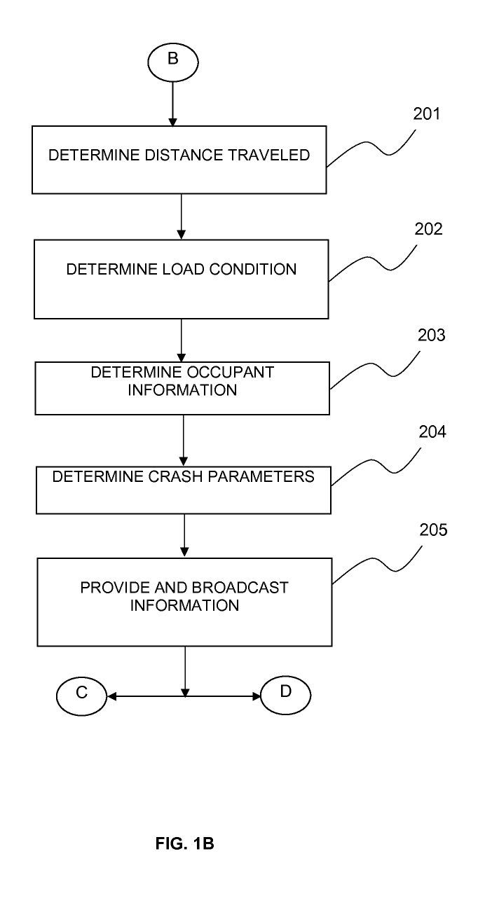

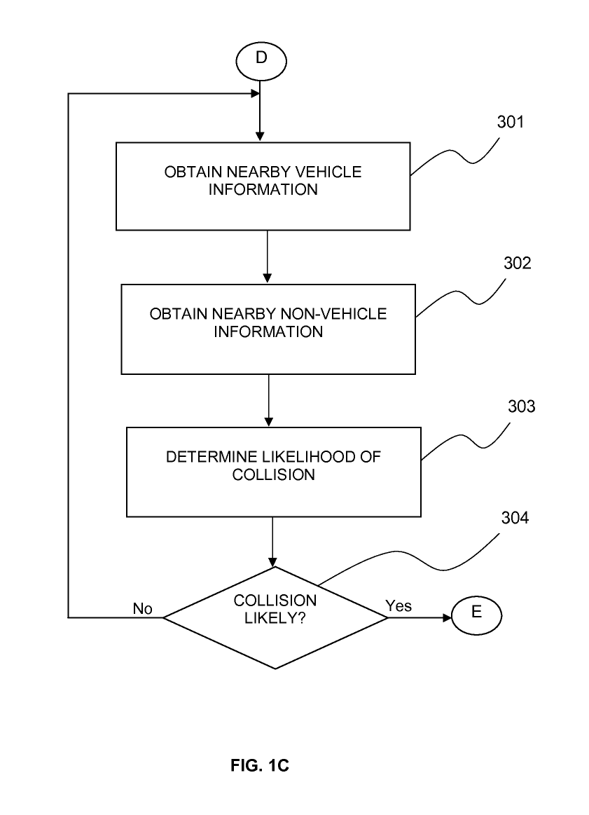

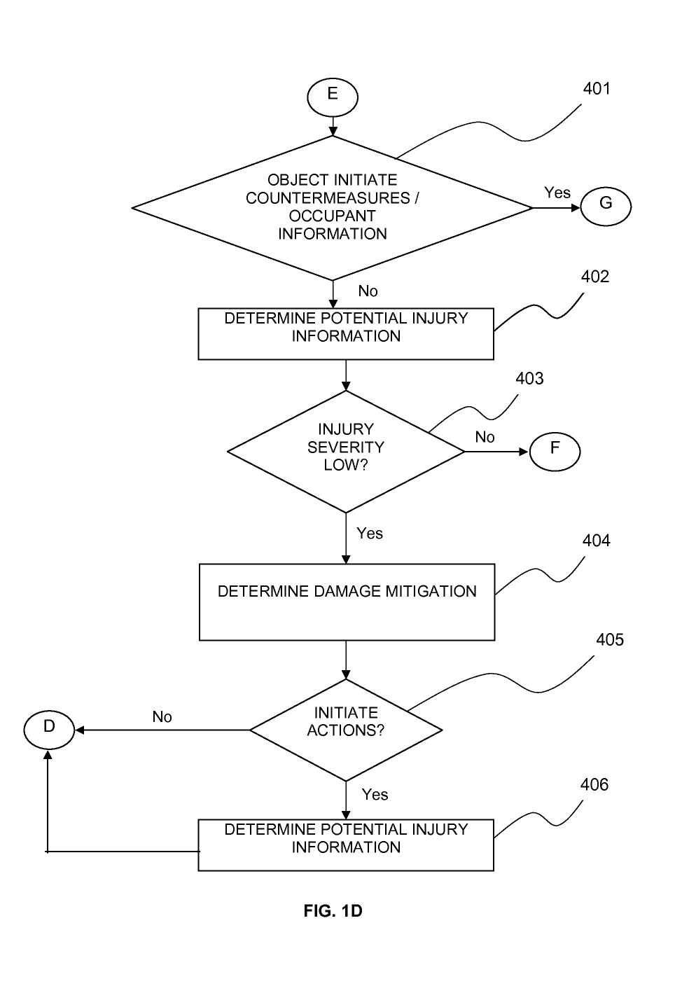

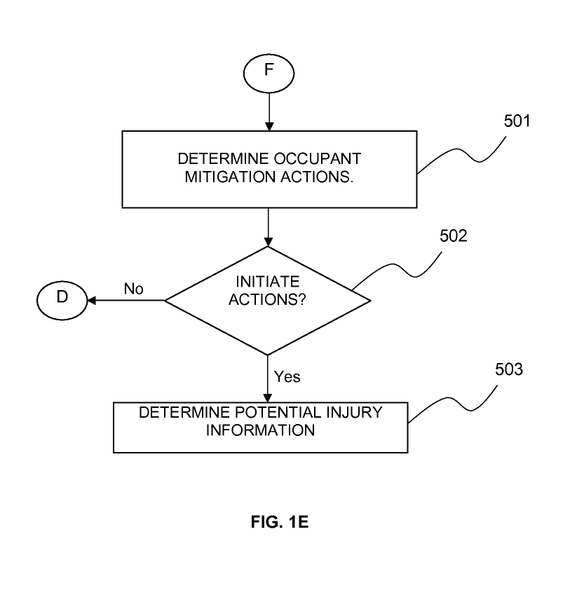

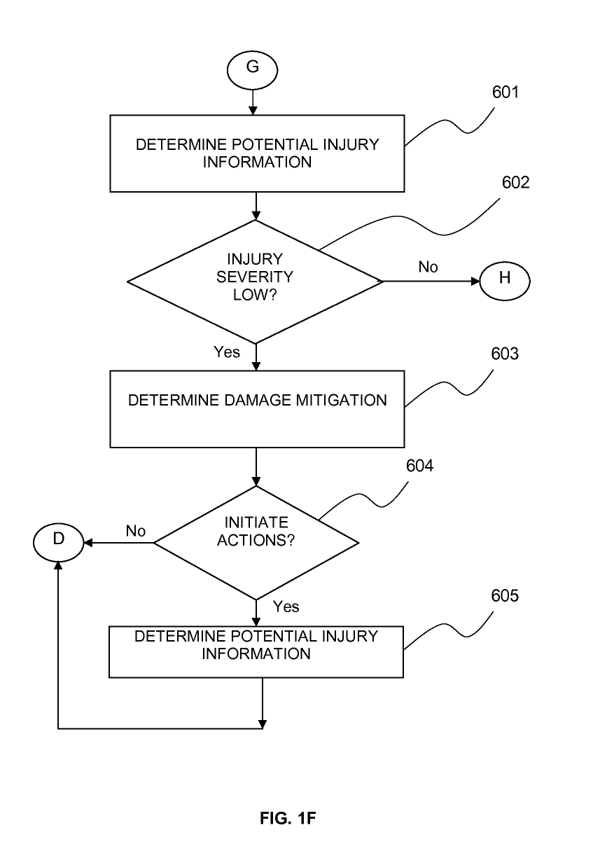

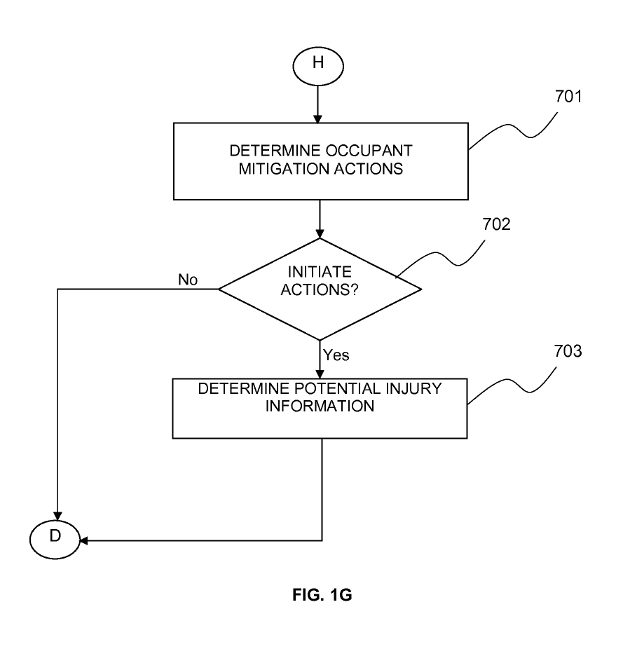

FIG. 1A is an exemplary flow chart illustrating a process for determining internal vehicle information, in accordance with an embodiment of the present disclosure. The internal information of the vehicle includes initial information provided in vehicle specifications, and dynamic information gathered by sensor means. Initial information includes body style, safety content and tire/wheel parameters, gathered from vehicle data and sensing systems explained in more detail below. Dynamic data includes vehicle tire pressure monitoring system, Anti-lock Braking System, pre-crash sensing means, and the like.

At step 101, the initial information is read by the Electronic Control Unit (ECU), which acts as the on-board processor. If the ignition is on, the ECU reads the vehicle tire and design parameters at step 102 from whatever storage site employed to maintain vehicle information. Using this information, all variable values are reset or standardized at step 103. A measurement loop begins at step 104, in which the number of loop iterations is tested against a preset standard (step 104), and a given number of samples are gathered. In each loop iteration, information about pressure and the number of revolutions made for each tire is gathered in real-time, at steps 105 and 106 respectively. Other vehicle systems, notably the tire pressure monitoring system and the Anti-lock Braking System (ABS) gather this information as a matter of course, so no particular measures need be implemented to obtain this information. In the absence of those systems, those of skill in the art could easily implement systems to sense and store such data.

FIG. 1B is a flow chart illustrating a continuation of the method begun in FIG. 1A, by estimating real-time vehicle crash parameters. Here, data about the real-time status of the vehicle loading conditions and its occupants are gathered and stored. At step 201, the distance travelled by the vehicle for the given time period being monitored in step 104 is determined. That information can be obtained, for example, from an on-board GPS system, or from a pre-crash sensing system, or Vehicle-to-Infrastructure, or the like.

Then, at step 202, the vehicle load condition can be determined by making use of the fact that for a given tire a known relationship between rolling radius, loading and tire pressure exists. Using the number of rotations of each tire determined in step 106 and comparing that to the distance that was traveled in step 201 the rolling radius of the tire can be determined. Knowing this and the tire pressure obtained in step 105, the actual loading condition of the tire can be determined via an equation or a lookup table. In order to reduce the effects of tire pressure variation, an average of each individual's tire loading condition, using multiple data samples could be considered. However, it is possible to determine precise tire pressure of each tire to calculate vehicle load conditions. Thus, average tire pressure calculated for determining the vehicle load condition should not be considered as a limitation of the present technology as disclosed in the present disclosure.

Next, vehicle occupant and cargo information, that is placed on a seat, is obtained at step 203. The term “occupant,” refers to any living beings, whether human or other animal within a vehicle, and cargo may refer to other goods within a vehicle. Cargo located on a seat and occupant information can be determined using an occupant identifier, a device that reads available passenger-related data such as seat pan pressure measurements, seat belt payout, and seat position. The processor analyses real-time sensed data and compares it with previously gathered data to form a probability assessment of the most likely number and location of occupants.

Using the previous determined information from steps 102, 203, and 204, a determination of crash parameters (vehicle mass, speed, occupant information, etc.) can be made, and broadcast to other systems via Vehicle-to-Vehicle and Vehicle-to-Infrastructure, shown in steps 204 and 205.

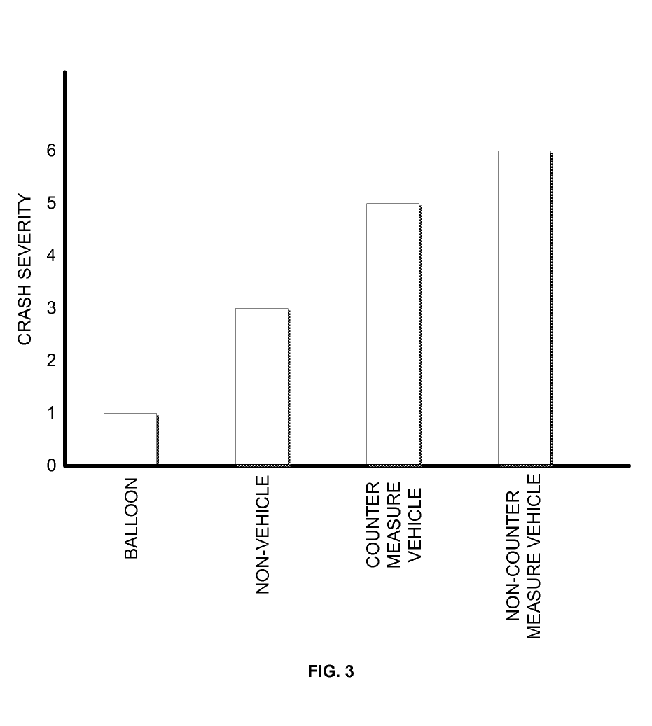

Having obtained information about the vehicle and its passengers, the system needs data about the vehicle's environment. A number of sensing systems are in common use on automotive vehicles, or could be easily implemented, all capable of providing information about a vehicle's surroundings as shown in the flowchart of FIG. 3C. Systems based on ultrasonic, infrared, laser or radar signals are all known in the art. Given the need for rapid, real-time data, radar and laser systems provide high accuracy and rapid response. Although such systems may not be generally implemented to provide 360° data, those skilled in the art will be able to modify existing systems to provide such coverage. However, these sensing systems are limited in their ability to determine data other than location of an object and general classification. To provide additional information about the external surrounding and potential targets, Vehicle-to-Vehicle and Vehicle-to-Infrastructure information can also be incorporated.

At step 301 and 302, sensing systems acquire data about surrounding vehicles and stationary objects, which can be referred to generally as “infrastructure”. That information can be combined with information collected as set out above to determine whether a short-term danger of collision exists, at step 303. In the event that a collision is calculated as likely, various alarm systems can sound in an effort to alert the driver to avoid the accident. Additionally, the system then proceeds to the next portion of the flowchart. The flowchart of FIG. 1D illustrates actions for determining if the object that the vehicle is likely to collide with, has the capability to initiate countermeasures on its own prior to the actual collision and for measuring occupant injury and vehicle damage mitigation, based on likelihood of collision information determined at step 303 in FIG. 1C. At step 401, the system determines whether the object that vehicle is likely to collide with has the capability to initiate countermeasures on its own prior to the actual collision and can communicate that capability.

At step 402, the system assesses the likelihood of occupant injury in the event that the anticipated collision does occur. Here, the system must take into account the anticipated effects of the collision as well as individual data about occupants, including individual characteristics about each occupant, location of each occupant, the deployment of passive restraints, and the likely effect of airbag deployment. Clearly, the system will not be in a position to estimate the effects in detail, but enough information will be collected to enable estimation of the severity of likely injury, at least classifiable into “low severity” and “high severity.”

After determination of the potential occupant injury, then the system branches, based upon the expected severity of occupant injury, at step 403. If the expected occupant injury severity is low, a determination of vehicle damage mitigation actions such as braking, steering, suspension etc, are conducted at step 404. Based on data collected in previous steps, the Electronic Control Unit determines if and when the vehicle damage mitigation actions and restraint devices based on a set of rules that dictate the behavior of the various restraining devices restraint mechanisms during an anticipated collision should be implemented. If the ECU determines that actions are appropriate, those actions are initiated at step 405. At step 406, the potential occupant injury information is updated following activation of mitigating actions.

If the occupant injury severity estimated as “not low” in step 403, then the actions shown in FIG. 1E are taken. Here, occupant injury mitigation is the primary factor in determining what actions to take are determined at step 501. The decision when to initiate mitigating actions is determined in steps 502. At step 503, the potential occupant injury information is updated following activation of mitigating actions, in a manner similar to that set out in steps 404, 405, and 406, above. Here, however, the system takes account of the anticipated increased levels of occupant injury severity possibilities in determining appropriate actions.

For the cases when the object that the system is going to collide with, can initiate countermeasures and/or communicate crash severity information as determined in step 401 (FIG. 1D), the processing shifts to FIG. 1F, where potential occupant injury information is estimated for not only the host vehicle's occupants, but also those of the object the is likely to collide with. If the occupant injury severity is low for both host and object occupants, then the damage mitigations actions are initiated at steps 603, 604, and 605. Calculations proceed in a manner identical to that set out above.

If either (host or object) occupant injury severity is not low, the system initiates occupant mitigations actions at step 701, FIG. 1G. The occupant mitigation action is taken at step 702 and 703, in a fashion identical to that set out above.

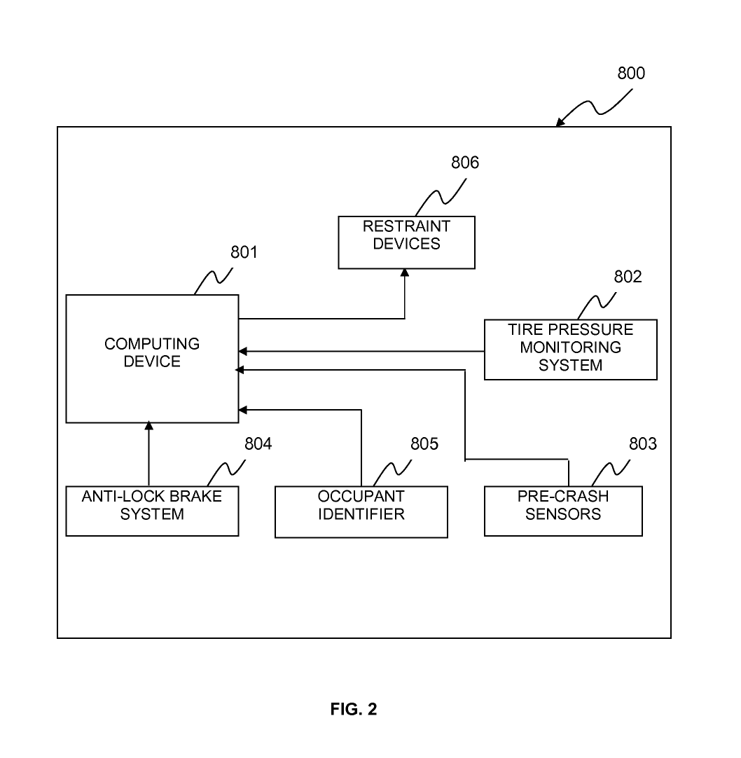

An embodiment of an exemplary block diagram of an optimum safety system 800 for estimating crash parameters of a vehicle in a real-time is diagrammatically illustrated in FIG. 2. At the heart of this system lies the Electronic Control Unit (ECU) 801, which provides computing power to accomplish the analysis steps set out above. Those skilled in the art will understand that the ECU can dedicate a portion of its resources to the task set out herein, or those tasks can be performed on a multi-threaded or time-sharing architecture. Those of skill in the art will understand how to employ either design structure.

Tire pressure information is provided by the tire pressure monitoring system 802. This system is generally conventional and need not be discussed further here. Suffice to note that the system can provide either average or individually sensed tire pressure data, which can then be employed to analyze the vehicle's real-time loading.

Anti-lock Braking System (ABS) 804 is another conventional system that is employed here to provide data that assist in determining vehicle crash parameters. Here, ABS 804 provides data used to calculate vehicle speed. The ABS 804 also monitors tire revolutions, and that data is useful in determining the rolling radius of each vehicle tire.

Occupant identifier 805 includes sensors that gather information related to the number and location of vehicle occupants. That information can be gathered by sensing seat pan pressure, seat belt payout, seat positions, and occupant positions.

Further, a pre-crash sensing means 803 determines external objects and potential crash parameters. The external crash parameters include information related to nearby vehicles, and infrastructure objects. That data can be combined with vehicle data to calculate, the likelihood of collision with a nearby vehicles or infrastructure object. Using this information an optimum safety system 800 can be enacted to enhance crash survivability of occupants and vehicle on or before collision.

As emphasized in the above description, external information such as, but not limited to type of object which is going to collide with the vehicle plays an important role in estimating crash parameters of the vehicle. For an example, if the vehicle is going to collide with an air balloon, the severity of crash as compared to, vehicle colliding with the building or electric pole is less. This is because the mass of the balloon is less than the mass of the building or electric pole. Hence, the mass of the type of object which is colliding with the vehicle determines the severity of the collision. Therefore, this necessitates determination of mass of the type of object to construct safety systems in the vehicle.

The listed systems are interconnected with the computing device 801. Each of the listed devices provides input data to the ECU, which then performs a calculating steps set out above. It should be recognized that advances in technology will very likely result in improved or different sensing devices in the future, but no such changes affect the scope of the present disclosure.

With reference to FIG. 3 and above illustrative examples, it is observed that crash severity increases together with the mass of the expected crash. This implies that the mass of both the vehicle and any expected impact object is a major parameter for vehicle safety in a crash.

Existing vehicle data contains limited information about vehicle load condition. Such systems are incapable of indicating whether the vehicle is empty, partially loaded, or fully loaded. Here, vehicle design data is of limited utility, because vehicle load varies during different driving conditions. The present disclosure sets out a method and system employing actual load conditions, and it uses that information to tailor the safety system response.

The specification has set out a number of specific exemplary embodiments, but those skilled in the art will understand that variations in these embodiments will naturally occur in the course of embodying the subject matter of the disclosure in specific implementations and environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. (canceled)

2. (canceled)

3. (canceled)

4. (canceled)

5. (canceled)

6. (canceled)

7. (canceled)

8. A system for estimating real-time vehicle crash parameters, the system comprising:
an apparatus for determining internal vehicle crash parameters, including:
a tire pressure monitoring system adopted to determine a vehicle load condition, using average tire pressure measured by tire pressure monitoring system of the vehicle, including determining a tire rolling radius;
an Anti-lock Braking System configured to calculate vehicle rolling radius based on the determined vehicle load condition;
an electronic control unit for calculating real-time vehicle-related crash parameters by comparing the vehicle-related inputs to predetermined crash parameters;
an occupant identifier to determine occupant-related crash parameters, the identifier including a device for measuring at least one of seat pan pressure, seat belt payout or seat position;
an apparatus for determining external crash parameters, including:
at least one of GPS sensor and a pre-crash sensing means to obtain information related to nearby vehicles and nearby infrastructure, wherein the pre-crash sensing means calculates likelihood of collision with at least one of the nearby vehicles and infrastructure; and
a computing unit connectable to the tire pressure monitoring system, the anti-lock brake system, the occupant identifier, GPS sensor, and the pre-crash sensing means to receive corresponding information and to process the received information to estimate the vehicle crash parameters.

9. The system according to claim 8, wherein the system further comprises a restraint device connectable to the computing device for receiving the estimated crash parameters to identify appropriate measure for mitigating occupant injury and vehicle damage based on feasibility of crash countermeasures application.

10. (canceled)

11. (canceled)

12. (canceled)

13. A vehicle comprising the system according to claim 8.

14. (canceled)

15. (canceled)

16. The system according to claim 8, wherein the system is configured to communicate crash severity information to an object it is going to collide with.

17. The system according to claim 16, wherein the object adopts countermeasures at least when:
an occupant injury severity is calculated to be low; and
the occupant injury severity is calculated to be high.

18. The system according to claim 8, wherein the system is configured to enact optimum countermeasures according to at least one of:
estimated occupant injury severity; and
estimated vehicle damage.
